(19) United States
(12) Patent Application Publication
(10) Pub. No.: US 2014/0114958 A1
(43) Pub. Date: Apr. 24, 2014

(54) METHOD AND SYSTEM FOR CALCULATING NUMBER OF USERS

(71) Applicant: HUAWEI TECHNOLOGIES CO., LTD., Shenzhen (CN)

(72) Inventors: Gang Shao, Shenzhen (CN); Xun HU, Shenzhen (CN)

(73) Assignee: HUAWEI TECHNOLOGIES CO., LTD., Shenzhen (CN)

(21) Appl. No.: 14/135,903

(22) Filed: Dec. 20, 2013

Related U.S. Application Data
(63) Continuation of application No. PCT/CN2011/078165, filed on Aug. 9, 2011.

(51) Int. Cl. G06F 17/30

(52) U.S. Cl. CPC G06F 17/30424; G06F 17/30554
USPC 707/722; 707/769

(57) ABSTRACT

Embodiments of the present invention disclose a method and a system for calculating the number of users, relate to the field of communication technologies, and solve a problem that the calculation amount is large and a lot of calculation resources are consumed because a location model needs to be established for each user for acquiring the number of users. In the embodiments of the present invention, a computer only needs to establish an attribute-number of location record mapping table according to locally stored location records of users and then may obtain a required result about the number of users according to time and location attributes in a query request. This overcomes a defect that a lot of calculation resources in the computer are consumed. Therefore, when a query condition frequently changes, the query can be sped up, and the query efficiency of the computer can be improved.

### CROSS-REFERENCE TO RELATED APPLICATIONS

This application is a continuation of International Application No. PCT/CN2011/078165, filed on Aug. 9, 2011, which is hereby incorporated by reference in its entirety.

### TECHNICAL FIELD

Embodiments of the present invention relate to the field of communications technologies, and in particular, to a method and a system for calculating the number of users.

### BACKGROUND

A location based service (Location Based Service, LBS for short) is a value-added service acquiring location information (longitude and latitude coordinates) of a mobile terminal user through a network (for example, GSM and CDMA networks) of a telecom mobile operator, and providing, under the support of an electronic map platform, corresponding services for the user.

In the prior art, technologies for acquiring location information of a mobile terminal user include: a network-based positioning technology, which estimates a location of a mobile terminal in a network by mainly using information such as the time when and the angle at which a mobile terminal device signal arrives at each base station; a terminal-based positioning technology, which obtains corresponding location information according to a GPS (Global Position System, global positioning system) satellite signal received by a mobile terminal from the GPS; and a hybrid positioning technology, which combines the advantages of the network-based positioning technology and terminal-based positioning technology and speeds up the positioning by using information about a mobile terminal in a base station in cooperation with a traditional GPS satellite.

An existing positioning technology may be used to position and acquire a user location record, obtain the number of users at a certain location or some certain locations at a certain time point in the past, and further obtain the number of users that have some attributes (attributes such as gender, age level, and occupation) according to user attributes.

In some cases (such as organizing an activity, allocating resources, and promoting a product in a certain region), the number of users that have a specific attribute at a certain location and a certain time point in the future needs to be obtained. For example, to send product content to 1000 male students, a product promoter needs to obtain the locations where the number of users may meet the promotion target, and may specify the locations as promotion locations. Therefore, a method for calculating the number of users based on a location and a time point in the future is put forward. An existing method for calculating the number of users include: recording location information of each user (that is, a mobile terminal) at every moment; establishing, according to a time-location record of an individual user, a location model of the user; acquiring, according to the location model, the location of the user at a certain time point in the future; repeating the preceding steps to acquire the locations of all users at the preceding certain time point in the future; and summarizing the location information of all users at the certain time point in the future to obtain the number of users at a certain location and the preceding certain time point in the future.

In a process of acquiring the number of users at a certain location and a certain time point in the future by using the preceding method for calculating the number of users, at least the following problem exists: In the existing method for calculating the number of users, a location model needs to be established for each user, and then the location of the user at a certain time point in the future is acquired according to the model. When the amount of users is large (million or ten millions), the calculation amount for establishing location models of all users is also large. Therefore, when a computer is used to implement the modeling process, a lot of calculation resources are consumed.

In addition, when acquiring the number of users, an enquirer frequently modifies a query condition (that is, a certain time point in the future and a certain location). Each time when the query condition is modified, a computer first recalculates the locations of all users at a certain time point in the future according to the location models of the users, and then summarizes the location information of all users at the certain time point in the future to obtain the number of users that appear at the certain location and the certain time point in the future. As the number of users increases, the calculation amount of the computer further increases. As a result, the system running speed slows down, and the query efficiency decreases.

### SUMMARY

Embodiments of the present invention provide a method and a system for calculating the number of users, which can simplify the calculation process and greatly save calculation resources of an apparatus.

To achieve the preceding objectives, the embodiments of the present invention adopt the following technical solutions:

A method for calculating the number of users includes: receiving, by a computer through an input interface, a query request that includes attribute parameters to be queried and is sent by an enquirer, where the attribute parameters to be queried include a location to be queried and time to be queried after the current time; querying, by the computer from a stored attribute-number of location record mapping table, the number of location records corresponding to the attribute parameters to be queried, where the attribute-number of location record mapping table is established by the computer according to locally stored location records of users and is stored in a memory; and obtaining, by the computer according to the obtained number of location records, the number of users at the location to be queried in the time to be queried.

A system for calculating the number of users includes: a data collection apparatus, configured to collect location information of users; and a computer, configured to receive, through an input interface, a query request that includes attribute parameters to be queried and is sent by an enquirer, where the attribute parameters to be queried include a location to be queried and time to be queried after the current time, then query from an attribute-number of location record mapping table stored in the computer, the number of location records corresponding to the attribute parameters to be queried, and finally calculate, according to the obtained number of location records, the number of users at the location to be queried in the time to be queried, where the data collection apparatus connects to another input interface of the computer to transmit the collected location information of users to the computer, so as to form location records corresponding to the collected users in the computer; and the computer is further configured to establish the attribute-number of location record mapping table according to locally stored location records of users and store the attribute-number of location record mapping table in a memory.

In the method and system for calculating the number of users according to the embodiments of the present invention, a computer only needs to establish, based on any mathematical statistic method, correspondence between user attributes and location records according to locally stored location records of users, that is, establish an attribute-number of location record mapping table. Then, the computer may obtain a required result about the number of users according to time and location attributes in a query request. This overcomes a defect that a lot of calculation resources are consumed because a location model needs to be established for each user in the prior art. In addition, only one attribute-number of location record mapping table needs to be stored in the computer. Compared with an existing location model corresponding to each user, the storage space of the computer is saved. Therefore, when a query condition frequently changes, the query can be sped up, and the query efficiency of the computer can be improved.

### BRIEF DESCRIPTION OF DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for calculating the number of users according to Embodiment 1 of the present invention;

FIG. 2 is a block diagram of a system for calculating the number of users according to Embodiment 1 of the present invention;

FIG. 3 is a flowchart of a method for calculating the number of users according to Embodiment 2 of the present invention;

FIG. 4 is a block diagram of a system for calculating the number of users according to Embodiment 3 of the present invention; and

FIG. 5 is a flowchart of a method for a computer to establish an attribute-number of location record mapping table according to Embodiment 2 of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

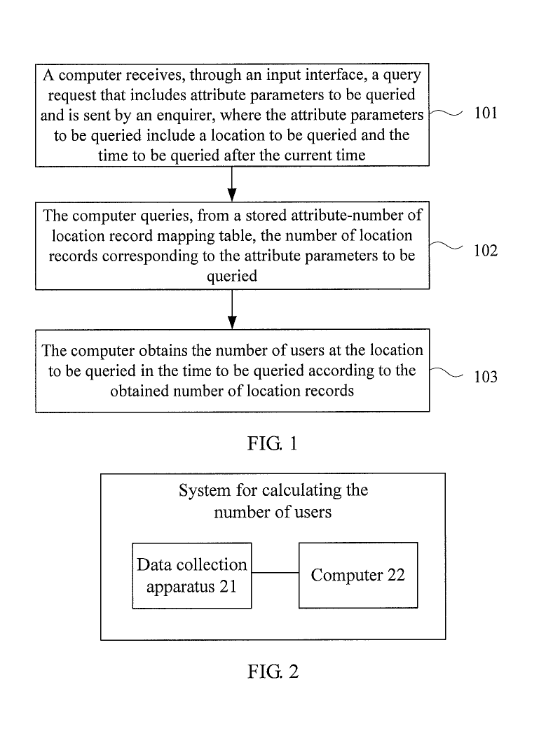

This embodiment provides a method for calculating the number of users, and an execution subject of the method is a computer. As shown in FIG. 1, the method includes the following steps:

101. A computer receives, through an input interface, a query request that includes attribute parameters to be queried and is sent by an enquirer, where the attribute parameters to be queried include a location to be queried and time to be queried after the current time.

To obtain the number of users that have a specific attribute at a certain location and a certain time point in the future, the enquirer needs to perform a query operation by using the computer. The computer receives, through the input interface, the query request sent by the enquirer and performs subsequent query and calculation operations according to the query request to obtain the number of users.

The enquirer may complete the query request by using various tools, for example, an electronic map to be described below or other tools known by a person skilled in the art.

The query request is composed of the attribute parameters to be queried. The parameters include the location to be queried and the time to be queried after the current time, and may also include some other attribute information, such as gender, occupation, and interests, included in location records of all users that are locally stored in the computer, so that the number of location records corresponding to the attribute parameters to be queried is obtained in a subsequent table query step. That is to say, the number of location records that have the other attribute information at the location to be queried in the time to be queried is obtained.

102. The computer queries, from a stored attribute-number of location record mapping table, the number of location records corresponding to the attribute parameters to be queried.

The attribute-number of location record mapping table is established by the computer according to the locally stored location records of users. The table is a mapping table of attributes included in the location records of all users and the number of location records corresponding to each of the attributes. The table reflects correspondence between user attributes and location records, and the number of location records corresponding to the attribute parameters to be queried may be obtained according to the correspondence. Certainly, a method for establishing correspondence between the user attributes and the location records is not limited to a method in the following embodiment and may be any modeling method in mathematical statistics.

The attribute parameters to be queried include the location to be queried and the time to be queried after the current time, and may also include some other attribute information included in the location records of all users. Therefore, the number of location records that have the other attribute information at the location to be queried in the time to be queried may be obtained.

Steps for forming the locally stored location records of users include the following: A data collection apparatus (for example, a base station or GPS terminal) periodically performs information collection according to a certain rule, where the collected information is location information of each user (that is, a mobile terminal), and the location information mainly includes collection time, user information, geographical location information, and the like, and may also include other attribute information, such as gender, occupation, and interests; and the computer forms, by using the collected location information, a location record corresponding to each user and stores the location record in a memory.

103. The computer obtains the number of users at the location to be queried in the time to be queried according to the obtained number of location records.

Specifically, the number of users at the location to be queried in the time to be queried may be obtained according to the number of location records obtained in step 102. When the query request includes other attribute information, the number of users that meet the other attribute information at the location to be queried in the time to be queried may also be obtained. In this way, the enquirer obtains the number of users that have a specific attribute at a certain location and a certain time point in the future.

In the method for calculating the number of users according to this embodiment, a computer only needs to establish correspondence between user attributes and location records based on any mathematical statistic method according to locally stored location records of users, that is, establish an attribute-number of location record mapping table. Then, the computer may obtain a required result about the number of users according to time and location attributes in a query request. This overcomes a defect that a lot of calculation resources are consumed because a location model needs to be established for each user in the prior art. In addition, only one attribute-number of location record mapping table needs to be stored in the computer. Compared with an existing location model corresponding to each user, the storage space of the computer is saved. Therefore, when a query condition frequently changes, the query can be sped up, and the query efficiency of the system can be improved.

This embodiment further provides a system for calculating the number of users. As shown in FIG. 2, the system includes: a data collection apparatus 21, configured to collect location information of users; and a computer 22, configured to receive, through an input interface, a query request that includes attribute parameters to be queried and is sent by an enquirer, where the attribute parameters to be queried include a location to be queried and time to be queried after the current time, then query, from an attribute-number of location record mapping table stored in the computer 22, the number of location records corresponding to the attribute parameters to be queried, and finally obtain, according to the obtained number of location records, the number of users at the location to be queried in the time to be queried.

The data collection apparatus connects to another input interface of the computer to transmit the collected location information of users to the computer, so as to form location records corresponding to the collected users in the computer.

The computer is further configured to establish the attribute-number of location record mapping table according to locally stored location records of users and store the attribute-number of location record mapping table in a memory.

The methods implemented by various apparatuses in the preceding system have been described in details in this embodiment, and therefore details are not provided herein.

In the system for calculating the number of users according to this embodiment, a computer only needs to establish, based on any mathematical statistic method, correspondence between user attributes and location records according to locally stored location records of users, that is, establish an attribute-number of location record mapping table. Then, the computer may obtain a required result about the number of users according to time and location attributes in a query request. This overcomes a defect that a lot of calculation resources are consumed because a location model needs to be established for each user in the prior art. In addition, only one attribute-number of location record mapping table needs to be stored in the computer. Compared with an existing location model corresponding to each user, the storage space of the computer is saved. Therefore, when a query condition frequently changes, the query can be sped up, and the query efficiency of the system can be improved.

### Embodiment 2

This embodiment provides a method for calculating the number of users, and an execution subject of the method is a computer. As shown in FIG. 3, the method includes the following steps:

301. A computer receives, through an input interface, a query request that includes attribute parameters to be queried and is sent by an enquirer, where the attribute parameters to be queried include a location to be queried and time to be queried after the current time.

To obtain the number of users that have a specific attribute at a certain location and a certain time point in the future, the enquirer needs to perform a query operation by using the computer. The computer receives, through the input interface, the query request sent by the enquirer and performs subsequent query and calculation operations according to the query request to obtain the number of users.

The enquirer may complete the query request by using various tools, for example, an electronic map to be described below or other tools known by a person skilled in the art.

The query request is composed of the attribute parameters to be queried. The parameters include the location to be queried and the time to be queried after the current time, and may also include some other attribute information, such as gender, occupation, and interests, included in location records of all users that are locally stored in the computer, so that the number of location records corresponding to the attribute parameters to be queried is obtained in a subsequent table query step. That is to say, the number of location records that have the other attribute information at the location to be queried in the time to be queried is obtained.

302. The computer queries, from a stored attribute-number of location record mapping table, the number of location records corresponding to the attribute parameters to be queried.

The attribute-number of location record mapping table is established by the computer according to the locally stored location records of users. The table is a mapping table of attributes included in the location records of all users and the number of location records corresponding to each of the attributes. The table reflects correspondence between user attributes and location records, and the number of location records corresponding to the attribute parameters to be queried may be obtained according to the correspondence. The attribute parameters to be queried include the location to be queried and the time to be queried after the current time, and may also include some other attribute information included in the location records of all users. Therefore, the number of location records that have the other attribute information at the location to be queried in the time to be queried may be obtained.

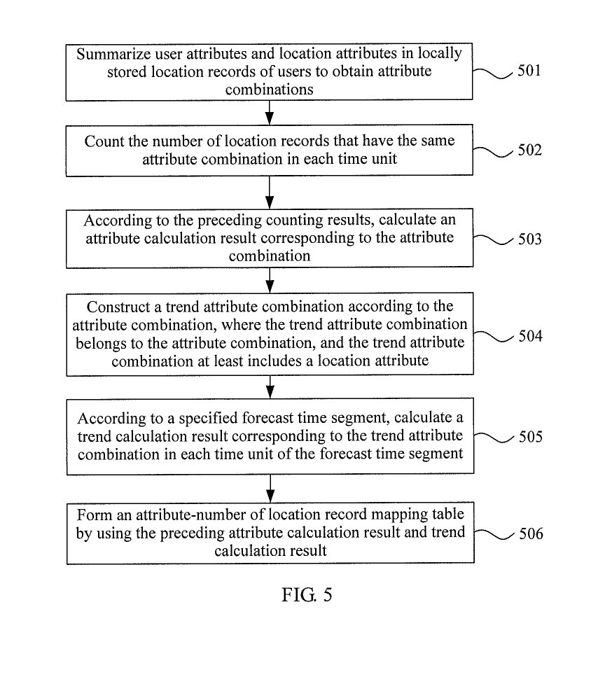

A method for establishing an attribute-number of location record mapping table is described in the following with reference to FIG. 5. Certainly, the method is not limited to the method shown in FIG. 5 and may be any modeling method in mathematical statistics. An execution subject of the method is a computer.

501. Summarize user attributes and location attributes in locally stored location records of users to obtain attribute combinations.

Specifically, a data collection apparatus (for example, a base station or GPS terminal) periodically collects location information of each user (that is, a mobile terminal) according to a certain rule, where the location information mainly includes collection time, user information, geographical location information, and the like, and may also include other attribute information, such as gender, occupation, and interests; and a computer forms, by using the collected location information, a location record corresponding to each user and stores the location record in a memory. The user information, the geographical location information, and the like included in the location records of users may separately serve as an attribute in a user information record. For example, the user information serves as a user attribute, and the geographical location information serves as a location attribute. A data collection time point, however, does not serve as an attribute.

At least one attribute combination included in all location records rather than data collection time points may form multiple attribute combinations. A set of data is used as an example to describe how to obtain attribute combinations in the following.

Sample data:

Dec. 9, 2010, Longitude and latitude (East longitude 114°04′12″ North latitude 22°37′12″), Name=North Huaqiang, Location category=shopping district, Country=China, Province=Guangdong, City=Shenzhen, Gender=male, and Brand=GoTone;

Dec. 10, 2010, Longitude and latitude (East longitude 114°04′12″ North latitude 22°37′12″), Name=North Huaqiang, Location category=shopping district, Country=China, Province=Guangdong, City=Shenzhen, Gender=male, and Brand=GoTone;

Dec. 9, 2010, Longitude and latitude (East longitude 114°04′12″ North latitude 22°37′12″), Name=North Huaqiang, Location category=shopping district, Country=China, Province=Guangdong, City=Shenzhen, Gender=female, and Brand=GoTone;

Dec. 10, 2010, Longitude and latitude (East longitude 114°04′12″ North latitude 22°37′12″), Name=North Huaqiang, Location category=shopping district, Country=China, Province=Guangdong, City=Shenzhen, Gender=female, and Brand=GoTone;

Dec. 9, 2010, Longitude and latitude (East longitude 114°05′2″ North latitude 22°38′1″), Name=Dongmen, Location category=shopping district, Country=China, Province=Guangdong, City=Shenzhen, Gender=male, and Brand=GoTone;

Dec. 10, 2010, Longitude and latitude (East longitude 114°05′2″ North latitude 22°38′1″), Name=Dongmen, Location category=shopping district, Country=China, Province=Guangdong, City=Shenzhen, Gender=male, and Brand=GoTone;

Dec. 9, 2010, Longitude and latitude (East longitude 114°05′2″ North latitude 22°38′1″), Name=Dongmen, Location category=shopping district, Country=China, Province=Guangdong, City=Shenzhen, Gender=female, and Brand=GoTone; and

Dec. 10, 2010, Longitude and latitude (East longitude 114°05′2″ North latitude 22°38′1″), Name=Dongmen, Location category=shopping district, Country=China, Province=Guangdong, City=Shenzhen, Gender=female, and Brand=GoTone;

in each piece of the preceding data, the first item is a data collection time point; the longitude and latitude, name, location category, country, province, and city are location attributes; the gender item is a gender attribute; and the brand item is a preference attribute. As can be seen that, the preceding data has four attribute combinations, which respectively are:

C1={East longitude 114°04′12″, North latitude 22°37′12″, North Huaqiang, shopping district, China, Guangdong, Shenzhen, male, GoTone};

C2={East longitude 114°04′12″, North latitude 22°37′12″, North Huaqiang, shopping district, China, Guangdong, Shenzhen, female, GoTone};

C3={East longitude 114°05′2″, North latitude 22°38′1″, Dongmen, shopping district, China, Guangdong, Shenzhen, male, GoTone}; and

C4={East longitude 114°05′2″, North latitude 22°38′1″, Dongmen, shopping district, China, Guangdong, Shenzhen, female, GoTone}.

502. Count the number of location records that have the same attribute combination in each time unit.

Specifically, location records of all users in a certain time unit tj are classified according to their attribute combinations, and then the number of location records (that is, the number of location records) that have the same attribute combination Ci is counted to obtain an attribute counting result L(Ci, tj). The time unit tj may be a day or an hour and may specifically be selected according to a calculation requirement.

After attribute combination classification and statistics are performed for location records of users in each time unit tj by using the preceding method, an attribute counting result L(Ci, tj) having the attribute combination Ci in each time unit tj is obtained, and then all attribute counting results having the same attribute combination in each time unit are summarized to form an attribute counting result set CL.

CLi={L(Ci, t0), L(Ci, t1), L(Ci, t2), . . . , L(Ci, tnow)}. tnow indicates the latest time unit, and t0 indicates the earliest time unit.

Take the data in step 501 as an example. The time unit is day. During the day Dec. 9, 2010, a location record corresponding to the attribute combination C1={East longitude 114°04′12″, North latitude 22°37′12″, North Huaqiang, shopping district, China, Guangdong, Shenzhen, male, GoTone} should be:

Dec. 9, 2010, Longitude and latitude (East longitude 114°04′12″ North latitude 22°37′12″), Name=North Huaqiang, Location category=shopping district, Country=China, Province=Guangdong, City=Shenzhen, Gender=male, and Brand=GoTone. The number of all user information records that include the attribute combination corresponding to the record is counted to obtain an attribute counting result. According to the method, attribute counting results corresponding to attribute combinations C2, C3, and C4 during the day Dec. 9, 2010 and attribute combinations C1, C2, C3, and C4 during the day Dec. 10, 2010 may be obtained.

If all data has been locally stored on the computer in step 501, the established attribute counting result set is CL1={1, 1}, CL2={1, 1}, CL3={1, 1}, and CL4={1, 1}.

503. According to the counting results in step 502, calculate an attribute calculation result corresponding to the attribute combination.

Specifically, according to the attribute counting result set obtained in step 502, an attribute calculation result corresponding to each attribute combination may be calculated by using the following formula (1):

$$base ( {C}_{1} ) = \frac{L ( {C}_{i} , {t}_{now} ) + L ( {C}_{i} , {t}_{now - 1} ) + … + L ( {C}_{i} , {t}_{now - n} )}{n + 1} \qquad ( 1 )$$

In formula (1), Ci indicates an i-th attribute combination, and i is a positive integer; tnow, tnow−1, . . . , and tnow-n respectively indicate different time units, and tnow−1 is the previous time unit of tnow; L(Ci, tnow), L(Ci, tnow−1), . . . , and L(Ci, tnow-n) respectively indicate the number of location records (that is, the number of location records) that have Ci in different time units; and base(Ci) indicates an attribute calculation result corresponding to Ci.

According to the attribute counting result set obtained in step 502, the following attribute counting result may be calculated and obtained as:

base(C1)=base(C2)=base(C3)=base(C4)=2/2=1

504. Construct a trend attribute combination according to the attribute combination, where the trend attribute combination belongs to the attribute combination, and the trend attribute combination at least includes a location attribute.

Specifically, the trend attribute combination is a subset of the attribute combination. For example, the attribute combination has five attributes {a, b, c, d, e}, and the trend attribute combination may be {a, d, e} or {a}. In practical applications, a trend attribute combination retains only an attribute sensitive to a time change. In this way, multiple attribute combinations may correspond to the same trend attribute combination. This may reduce the trend calculation amount and the storage capacity of calculation results. Trend attributes at least include a location attribute, because calculation about the number of users is to calculate the number of users at a certain location. Therefore, the location attribute is a core attribute. In a trend attribute combination, a specific location attribute may be selected according to a calculation requirement. Take the sample data in step 501 as an example. The location attribute may be any one or more of the location category, country, province, city, and name.

505. According to a specified time segment to be queried, calculate a trend calculation result corresponding to the trend attribute combination in each time unit of the time segment to be queried.

Specifically, according to a requirement of an enquirer, the time segment to be queried may be specified and includes a start time tw and the total number of time units that start with the start time tw and require calculation. For example, the time unit is day, the specified start time is Jan. 1, 2011, and the number of days that start with Jan. 1, 2011 and require query is seven. Then, the seven days from Jan. 1, 2011 to Jan. 7, 2011 are the time segment to be queried.

The trend calculation result may be calculated according to the following formula:

direction(Cᵢ^{d},t_{w})=d_{w}×Day_{avg}(Cᵢ^{d},t_{w})+w_{w}×Week_{avg}(Cᵢ^{d},t_{w})+m_{w}+Month_{avg}(Cᵢ^{d},t_{w})+y_{w}×Year_{avg}(Cᵢ^{d},t_{w}) (2)

In formula (2), Cᵢ^{d} indicates an i-th trend attribute combination; tw indicates a w-th time unit in the time segment to be queried; Day_{avg}(Cᵢ^{d}, t_{w}) indicates a daily calculation component, and dw indicates a weight of the daily calculation component; Week_{avg}(Cᵢ^{d}, t_{w}) indicates a weekly calculation component, and ww indicates a weight of the weekly calculation component; Month_{avg}(Cᵢ^{d}, t_{w}) indicates a monthly calculation component, and mw indicates a weight of the monthly calculation component; and Year_{avg}(Cᵢ^{d}, t_{w}) indicates a yearly calculation component, yw indicates a weight of the yearly calculation component, and d_{w}+w_{w}+m_{w}+y_{w}=1, and direction(Cᵢ^{d}, t_{w}) indicates a trend calculation result of Cᵢ^{d} in tw, where

dw, ww, mw, and yw are constants and may be selected according to experience, and Day_{avg}(Cᵢ^{d}, t_{w}), Week_{avg}(Cᵢ^{d}, t_{w}), Month_{avg}(Cᵢ^{d}, t_{w}), and Year_{avg}(Cᵢ^{d}, t_{w}) are respectively calculated according to the following formulas:

$${Day}_{avg} ( {C}_{i}^{d} , {t}_{w} ) = \frac{K ( {C}_{i}^{d} , {t}_{Day ( w , 1 )} ) + K ( {C}_{i}^{d} , {t}_{Day ( w , 2 )} ) + … + K ( {C}_{i}^{d} , {t}_{Day ( w , n )} )}{n} ;$$

$${Week}_{avg} ( {C}_{i}^{d} , {t}_{w} ) = \frac{K ( {C}_{i}^{d} , {t}_{Week ( w , 1 )} ) + K ( {C}_{i}^{d} , {t}_{Week ( w , 2 )} ) + … + K ( {C}_{i}^{d} , {t}_{Week ( w , n )} )}{n} ;$$

$${Month}_{avg} ( {C}_{i}^{d} , {t}_{w} ) = \frac{K ( {C}_{i}^{d} , {t}_{Month ( w , 1 )} ) + K ( {C}_{i}^{d} , {t}_{Month ( w , 2 )} ) + … + K ( {C}_{i}^{d} , {t}_{Month ( w , n )} )}{n} ;$$

$${Year}_{avg} ( {C}_{i}^{d} , {t}_{w} ) = \frac{K ( {C}_{i}^{d} , {t}_{Year ( w , 1 )} ) + K ( {C}_{i}^{d} , {t}_{Year ( w , 2 )} ) + … + K ( {C}_{i}^{d} , {t}_{Year ( w , n )} )}{n} ;$$

$$where K ( {C}_{i}^{d} , {t}_{Day ( w , n )} ) = \frac{L ( {C}_{i}^{d} , {t}_{Day ( w , n )} )}{L ( {C}_{i}^{d} , {t}_{now} )} , \\ K ( {C}_{i}^{d} , {t}_{Week ( w , n )} ) = \frac{L ( {C}_{i}^{d} , {t}_{Week ( w , n )} )}{L ( {C}_{i}^{d} , {t}_{now} )} , \\ K ( {C}_{i}^{d} , {t}_{Month ( w , n )} ) = \frac{L ( {C}_{i}^{d} , {t}_{Month ( w , n )} )}{L ( {C}_{i}^{d} , {t}_{now} )} , and$$

$$K ( {C}_{i}^{d} , {t}_{Year ( w , n )} ) = \frac{L ( {C}_{i}^{d} , {t}_{Year ( w , n )} )}{L ( {C}_{i}^{d} , {t}_{now} )} ;$$

t_{Day(w,n)} indicates a time unit in the latest n-th week that has the same date order number as the week to which tw belongs, t_{Week(w,n)} indicates a time unit in the latest n-th month that has the same week order number as the month to which tw belongs, t_{Month(w,n)} indicates a time unit in the latest n-th month that has a different month from and the same date as tw, and t_{Year(w,n)} indicates a time unit in the latest n-th year that has a different year from and the same date as tw.

For example, tw is Mar. 30, 2011, which is Wednesday in the fifth week of March. Then, t_{Day(w,1)} is Wednesday in the fourth week of March, that is, Mar. 23, 2011; t_{Day(w,2)} is Wednesday in the third week of March, that is, Mar. 16, 2011; t_{Day(w,3)} and t_{Day(w,4)} may be deduced by analogy; and t_{Week(w,1)} is Wednesday in the last fifth week. Because February has no fifth week, t_{Week(w,1)} is January 26.

L(Cᵢ^{d}, t_{Day(w,n)}) indicates the number of location records (that is, the number of location records) corresponding to Cᵢ^{d} in t_{Day(w,n)}, L(Cᵢ^{d}, t_{Week(w,n)}) indicates the number of location records (that is, the number of location records) corresponding to Cᵢ^{d} in t_{Week(w,n)}, L(Cᵢ^{d}, t_{Month(w,n)}) indicates the number of location records (that is, the number of location records) corresponding to Cᵢ^{d} in t_{Month(w,n)}, and L(Cᵢ^{d}, t_{Year(w,n)}) indicates the number of location records (that is, the number of location records) corresponding to Cᵢ^{d} in t_{Year(w,n)}; and L(Cᵢ^{d}, t_{now}) indicates the number of location records (that is, the number of location records) corresponding to Cᵢ^{d} in the latest time unit.

According to the preceding calculation method, a trend calculation result of each trend attribute combination Cᵢ^{d} in a trend attribute combination set respectively in each time unit from tw to tw+m: direction(Cᵢ^{d}, t_{w+1}), direction(Cᵢ^{d}, t_{w+2}), . . . , and direction(Cᵢ^{d}, t_{w+m}). According to the preceding calculation formula, the trend calculation result is a time weight sequence of a relevant attribute calculation result in the specified time segment to be queried.

506. Form the attribute-number of location record mapping table by using an attribute calculation result corresponding to each attribute combination and a trend calculation result corresponding to each trend attribute combination in each time unit of the time segment to be queried.

The attribute-number of location record mapping table may be expressed by using the following sets and stored in the memory of the computer for subsequent calculation of the number of users.

$$\{ \begin{matrix}{C}_{1} & base ( {C}_{1} ) \\ {C}_{2} & base ( {C}_{2} ) \\ … & … \\ {C}_{p} & base ( {C}_{p} )\end{matrix} \}$$

$$\{ \begin{matrix}{C}_{1}^{d} & direction ( {C}_{1}^{d} , {t}_{w} ) & direction ( {C}_{1}^{d} , {t}_{w + 1} ) & … & direction ( {C}_{1}^{d} , {t}_{w + m} ) \\ {C}_{2}^{d} & direction ( {C}_{2}^{d} , {t}_{w} ) & direction ( {C}_{2}^{d} , {t}_{w + 1} ) & … & direction ( {C}_{2}^{d} , {t}_{w + m} ) \\ … & … & … & … & … \\ {C}_{q}^{d} & direction ( {C}_{q}^{d} , {t}_{w} ) & direction ( {C}_{q }^{d} , {t}_{w + 1} ) & … & direction ( {C}_{q}^{d} , {t}_{w + m} )\end{matrix} \}$$

The preceding step 501 to step 506 describe the detailed process of a method for establishing an attribute-number of location record mapping table according to location records of all users. Certainly, a method for establishing correspondence between user attributes and numbers of location records is not limited to the method described in this embodiment. The preceding correspondence may also be established according to statistic features of time and location attributes in the location records of users or other modeling methods in mathematical statistics known by a person skilled in the art.

After the preceding attribute-number of location record mapping table is established in the computer, the number of location records corresponding to the attribute parameters to be queried can be obtained by performing step 302 in this embodiment. Step 302 may specifically include the following sub-steps:

3021. Query, from the attribute combinations, an attribute combination including the location to be queried, and specify the attribute combination as a matched attribute combination.

The attribute parameters to be queried in the query request include the location to be queried. In all attribute combinations, as long as a queried attribute combination includes the location to be queried, the queried attribute combination is a matched attribute combination MCi, regardless of whether the queried attribute combination includes other attributes and regardless of the values of these other attributes.

3022. Query, from the attribute-number of location record mapping table, an attribute calculation result corresponding to the matched attribute combination and a trend calculation result corresponding to a corresponding trend attribute combination in the time to be queried.

Specifically, from the attribute-number of location record mapping table obtained by calculation in step 501 to step 506, an attribute calculation result base(MCi) corresponding to the matched attribute combination MCi is queried and then a corresponding trend calculation result direction (MCᵢ^{d}, t) is queried according to the time t to be queried and a trend attribute combination MCᵢ^{d} corresponding to the matched attribute combination MCi. The attribute calculation result base(MCi) and the trend calculation result direction(MCᵢ^{d}, t) form the obtained number of location records.

303. According to the attribute calculation result corresponding to the matched attribute combination and the trend calculation result corresponding to the corresponding trend attribute combination in the time to be queried, calculate the number of users at the location to be queried in the time to be queried, and use the following formula to calculate the number of users at the location to be queried in the time to be queried.

Specifically, the number of users is calculated according to the following formula:

count=Σ(base(MCᵢ)×direction(MCᵢ^{d},t)) (3)

In the preceding formula (3), Σ is a summation symbol. Count indicates the number of users; MCi indicates an i-th matched attribute combination, and i is a positive integer; MCᵢ^{d} indicates a trend attribute combination corresponding to MCi; base(MCi) indicates an attribute calculation result corresponding to MCi; and direction(MCᵢ^{d}, t) indicates a trend calculation result corresponding to MCᵢ^{d} in the time t to be queried.

Steps for obtaining the number of users at the location to be queried in the time to be queried may be as follows: Multiply the attribute calculation result base(MCi) by the trend calculation result direction(MCᵢ^{d}, t) to obtain an intermediate result; finally, calculate intermediate results of all matched attribute combinations according to the preceding method, and then add the intermediate results together to obtain the number (count) of users at the location to be queried in the time to be queried.

If a range of the location to be queried is relatively large, for example, multiple data collection points exist in the range and each collection point has a different longitude and latitude, for the purpose of obtaining a result about the number of users at each collection point in the range, the following may further be included between step 3021 and step 3022: dividing the matched attribute combinations into matched attribute combination subsets according to the location attributes. According to the sample data in step 501, it can be known that the longitude and latitude, name, location category, country, province, and city are the location attributes. When the matched attribute combinations are divided into matched attribute combination subsets according to the longitude and latitude, different matched attribute combination subsets have different longitude and latitude attributes.

Then, an attribute calculation result corresponding to each matched attribute combination in the matched attribute combination subsets and a trend calculation result corresponding to a corresponding trend attribute combination in the time to be queried are queried from the attribute-number of location record mapping table.

Then, in step 303, all matched attribute combination subsets may be calculated according to formula (3) to obtain the number of users at the location to be queried in the time to be queried.

By further dividing the matched attribute combinations into the matched attribute combination subsets according to the location attributes, not only the obtained number of users is allowed to be specifically in a small range in the location to be queried, but also the speed of calculating the number of users in the range is improved. In this way, a calculation result about the number of users in the range can be fast obtained in real time.

Certainly, the query request may also include some other attribute information, such as gender, occupation, and interests, included in the location records of users to obtain the number of users that have the other attribute information at the location to be queried in the future time to be queried.

If a new query request is received after the number (count) of users at the location to be queried in the time to be queried is obtained, and only the time to be queried in the query request is changed (the new time to be queried is t′), the number of users may be fast recalculated according to the following formula:

$${count}^{′} = count \times \frac{direction ( {C}_{i}^{d} , {t}^{′} )}{direction ( {C}_{i}^{d} , t )} ,$$

where count′ is the number of users that corresponds to the new time to be queried, and direction(C′ᵢ^{d}, t′) is a trend calculation result corresponding to Cᵢ^{d} in the new time to be queried. This algorithm allows a computer to fast calculate a new result without re-querying an attribute calculation result and an attribute calculation result, greatly improving the calculation speed.

A method for calculating the number of users is described in the following by using a specific example.

Assume that an established attribute-number of location record mapping table is composed of attribute calculation results

$$\{ \begin{matrix}{C}_{1} & 580 \\ {C}_{2} & 700 \\ {C}_{3} & 900 \\ {C}_{4} & 800\end{matrix} \}$$

and trend calculation results Cᵢ^{d} (1.0, 1.3, 1.6, 0.9, 1.1, 1.3, 1.1). The Cᵢ^{d} is trend attribute combinations corresponding to C1, C2, C3, and C4, the start time of the trend calculation results is Jan. 1, 2011, and the trend calculation results of seven days is obtained. C1, C2, C3, and C4 are attribute combinations of the sample data in step 501:

C1={East longitude 114°04′12″, North latitude 22°37′12″, North Huaqiang, shopping district, China, Guangdong, Shenzhen, male, GoTone};

C2={East longitude 114°04′12″, North latitude 22°37′12″, North Huaqiang, shopping district, China, Guangdong, Shenzhen, female, GoTone};

C3={East longitude 114°05′2″, North latitude 22°38′1″, Dongmen, shopping district, China, Guangdong, Shenzhen, male, GoTone}; and

C4={East longitude 114°05′2″, North latitude 22°38′1″, Dongmen, shopping district, China, Guangdong, Shenzhen, female, GoTone}.

Cᵢ^{d}: Location category=shopping district.

When an input query condition is C={City=Shenzhen, Location category=shopping district, Gender=male, Time to be queried=Jan. 3, 2011}, a matched attribute combination is {C1, C3} and divided into two matched attribute combination subsets {C1} and {C3} according to the longitude and latitude.

It should be noted that, the query condition further includes a gender attribute in addition to location attributes. Therefore, the calculation result about the number of users should be the number of users whose gender attribute is male and who are at the location specified by the preceding location attributes in the time to be queried.

The number of users corresponding to the matched attribute combination subset {C1} is base(C₁)×direction(C₁^{d}, t)=580×1.6=928; and the number of users corresponding to the matched attribute combination subset {C3} is base(C₃)×direction(C₁^{d}, t)=900×1.6=1440.

The number of users at the location to be queried in the time to be queried may be obtained by performing the preceding step 301 to step 303. In the method for calculating the number of users, a computer only needs to establish correspondence between user attributes and location records based on any mathematical statistic method according to locally stored location records of users, that is, establish an attribute-number of location record mapping table. Then, the computer may obtain a required result about the number of users according to time and location attributes in a query request. This overcomes a defect that a lot of calculation resources are consumed because a location model needs to be established for each user in the prior art. Furthermore, only one attribute-number of location record mapping table needs to be stored in the computer. Compared with an existing location model corresponding to each user, the storage space of the computer is saved. Therefore, the query speed of the computer can be increased when a query condition frequently changes. In addition, matched attribute combinations are further divided into matched attribute combination subsets according to the location attributes when the number of users is calculated. This can faster obtain a calculation result about the number of users in real time.

In the establishment process of the attribute-number of location record mapping table, before the user attributes and location attributes in the locally stored location records of all users are summarized to obtain attribute combinations, data collection and preprocessing steps may further be included. The steps include: periodically recording, according to the time unit, user identifiers, collection time, and location identifiers of users meeting collection conditions; and performing attribute expansion on the user identifiers and location identifiers according to an attribute database to form location records corresponding to the user identifiers, collection time, and location identifiers.

The periodically recording, according to the time unit, user identifiers, collection time, and location identifiers of users meeting collection conditions may include: recording, by a positioning system, according to a record triggering condition, user identifiers, collection time, and location identifiers of users entering and/or leaving a certain location area of the positioning system.

The specific data collection and preprocessing steps may not be limited to the preceding steps and may also be directly collecting and saving data for calculating the number of users to form location records of users.

In addition, when the received query request is a query request sent by the enquirer through an electronic map, the method for calculating the number of users may further include displaying, at the location corresponding to the location to be queried on the electronic map, the number of users at the location to be queried in the time to be queried. Therefore, the enquirer may intuitively view a calculation result about the number of users. The receiving a query request sent by the enquirer through an electronic map may specifically include receiving a query request sent by the enquirer by operating a display area (for example, using the mouse to select a certain location in the display area as the location to be queried) in the electronic map; or include receiving a query request sent by the enquirer by operating a time selection control (for example, using the mouse to drag a slider on a time axis set on the electronic map to a certain location to determine the time to be queried) in the electronic map.

### Embodiment 3

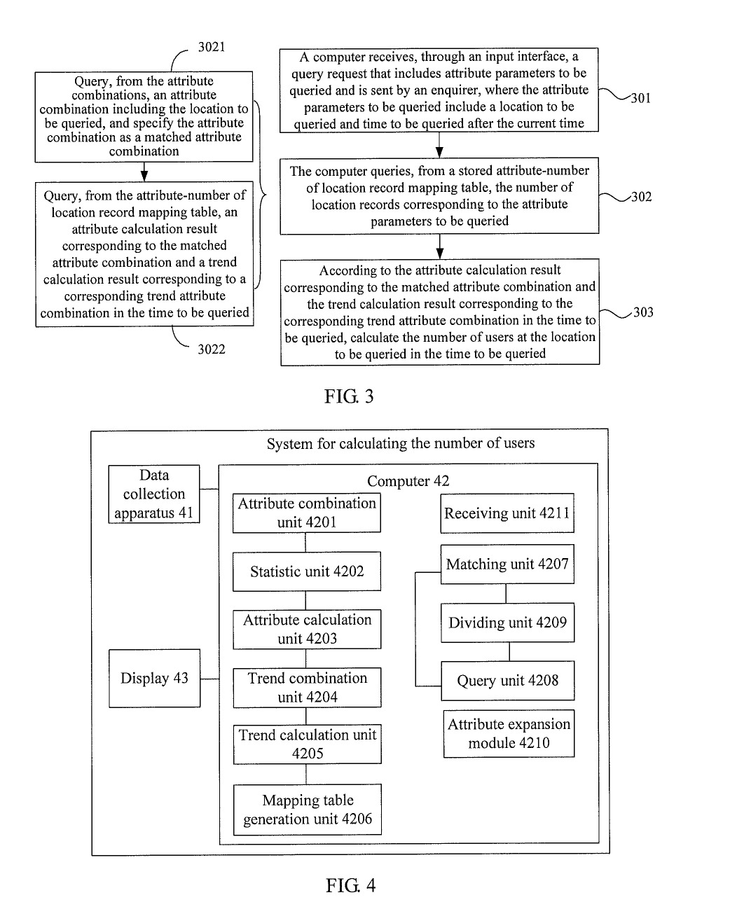

This embodiment provides a system for calculating the number of users. As shown in FIG. 4, the system includes: a data collection apparatus 41, configured to collect location information of users; and a computer 42, configured to receive, through an input interface, a query request that includes attribute parameters to be queried and is sent by an enquirer, where the attribute parameters to be queried include a location to be queried and time to be queried after the current time, then query, from an attribute-number of location record mapping table stored in the computer, the number of location records corresponding to the attribute parameters to be queried, and finally calculate, according to the obtained number of location records, the number of users at the location to be queried in the time to be queried.

The data collection apparatus 41 connects to another input interface of the computer 42 to transmit the collected location information of users to the computer, so as to form location records corresponding to the collected users in the computer 42; and the computer 42 is further configured to establish the attribute-number of location record mapping table according to locally stored location records of users and store the attribute-number of location record mapping table in a memory.

The computer 42 in the system may include: an attribute combination unit 4201, configured to obtain attribute combinations by summarizing user attributes and location attributes in the locally stored location records of users; a statistic unit 4202, configured to count the number of location records that have the same attribute combination in each time unit; an attribute calculation unit 4203, configured to calculate, according to a counting result about the number of location records, an attribute calculation result corresponding to the attribute combination; a trend combination unit 4204, configured to construct a trend attribute combination according to the attribute combination, where the trend attribute combination belongs to the attribute combination, and the trend attribute combination at least includes a location attribute; a trend calculation unit 4205, configured to calculate, according to a specified time segment to be queried, a trend calculation result corresponding to the trend attribute combination in each time unit of the time segment to be queried; and a mapping table generation unit 4206, configured to form the attribute-number of location record mapping table by using an attribute calculation result corresponding to each attribute combination and a trend calculation result corresponding to each trend attribute combination in each time unit of the time segment to be queried.

The computer 42 may further include: a matching unit 4207, configured to query, from the attribute combinations, an attribute combination including the location to be queried and specify the attribute combination as a matched attribute combination; and a query unit 4208, configured to calculate, according to an attribute calculation result corresponding to the matched attribute combination and a trend calculation result corresponding to a corresponding trend attribute combination in the time to be queried, the number of users at the location to be queried in the time to be queried.

The computer 42 may further include a dividing unit 4209, configured to divide the matched attribute combination into matched attribute combination subsets according to the location attributes; and the calculating unit 4208 is further configured to calculate, according to an attribute calculation result corresponding to each matched attribute combination in the matched attribute combination subsets and a trend calculation result corresponding to a corresponding trend attribute combination in the time to be queried, the number of users at the location to be queried in the time to be queried.

The data collection apparatus 41 may further be configured to periodically record, according to the time unit, user identifiers, collection time, and location identifiers of users meeting collection conditions; and the computer 42 may further include an attribute expansion module 4210, configured to perform attribute expansion on the user identifiers and location identifiers according to an attribute database to form location records corresponding to the user identifiers, collection time, and location identifiers.

The data collection apparatus 41 may further be configured to record, according to a record triggering condition, user identifiers, collection time, and location identifiers of users entering and/or leaving a certain location area of the positioning system.

The computer 42 may further include a receiving unit 4211, configured to receive, through the input interface, a query request that includes attribute parameters to be queried and is sent by the enquirer through an electronic map, where the query request includes the location to be queried and the time to be queried. In addition, the system for calculating the number of users may further include a display 43, configured to display, at the location corresponding to the location to be queried on the electronic map, the number of users at the location to be queried in the time to be queried.

The receiving unit 4211 may further be configured to receive a query request that includes attribute parameters to be queried and is sent by an enquirer by operating a display area in the electronic map; or receive a query request that includes attribute parameters to be queried and is sent by an enquirer by operating a time selection control in the electronic map, where the query request includes the location to be queried and the time to be queried.

The methods implemented by the preceding modules and units have been described in details in Embodiment 1 and Embodiment 2, and therefore details are not provided herein.

In the system for calculating the number of users according to this embodiment, a computer only needs to establish correspondence between user attributes and location records based on any mathematical statistic method according to locally stored location records of users, that is, establish an attribute-number of location record mapping table. Then, the computer may obtain a required result about the number of users according to time and location attributes in a query request. This overcomes a defect that a lot of calculation resources are consumed because a location model needs to be established for each user in the prior art. Furthermore, only one attribute-number of location record mapping table needs to be stored in the computer. Compared with an existing location model corresponding to each user, the storage space of the computer is saved. Therefore, the query speed of the computer can be increased when a query condition frequently changes. In addition, matched attribute combinations are further divided into matched attribute combination subsets according to the location attributes when the number of users is calculated. This can faster obtain a calculation result about the number of users in real time.

According to the description about the preceding embodiments, a person skilled in the art may be clearly aware of that the present invention may be implemented by using software plus necessary universal hardware, and definitely may also be implemented by using hardware, but in most cases, the present invention is preferably implemented by using the former method. Based on such an understanding, the technical solutions of the present invention essentially or the part contributing to the prior art may be implemented in the form of a software product. The computer software product is stored in a readable storage medium such as a floppy disk, a hard disk, or an optical disc of a computer, and includes several instructions for instructing a computer device (which may be a personal computer, a server, a network device, or the like) to perform the methods described in the embodiments of the present invention.

The embodiments of the present invention are mainly used for location based services.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for calculating the number of users, comprising:
receiving, by a computer through an input interface, a query request that comprises attribute parameters to be queried and is sent by an enquirer, wherein the attribute parameters to be queried comprises a location to be queried and time to be queried after the current time;
querying, by the computer from a stored attribute-number of location record mapping table, the number of location records corresponding to the attribute parameters to be queried, wherein the attribute-number of location record mapping table is established by the computer according to locally stored location records of users and is stored in a memory; and
obtaining, by the computer according to the obtained number of location records, the number of users at the location to be queried in the time to be queried.

2. The method for calculating the number of users according to claim 1, wherein a method for establishing the attribute-number of location record mapping table according to the locally stored location records of users comprises:
summarizing user attributes and location attributes in the locally stored location records of users to obtain attribute combinations;
counting the number of location records that have the same attribute combination in each time unit;
calculating, according to a counting result about the number of location records, an attribute calculation result corresponding to the attribute combination;
constructing a trend attribute combination according to the attribute combination, wherein the trend attribute combination belongs to the attribute combination, and the trend attribute combination at least comprises a location attribute;
calculating, according to a specified time segment to be queried, a trend calculation result corresponding to the trend attribute combination in each time unit of the time segment to be queried; and
forming the attribute-number of location record mapping table by using an attribute calculation result corresponding to each attribute combination and a trend calculation result corresponding to each trend attribute combination in each time unit of the time segment to be queried.

3. The method for calculating the number of users according to claim 2, wherein the attribute calculation result corresponding to the attribute combination is calculated by using the following formula:
$$base ( {C}_{1} ) = \frac{L ( {C}_{i} , {t}_{now} ) + L ( {C}_{i} , {t}_{now - 1} ) + … + L ( {C}_{i} , {t}_{now - n} )}{n + 1}$$
wherein Ci indicates an i-th attribute combination, and i is a positive integer; tnow, tnow−1, . . . , and tnow-n respectively indicate different time units, and tnow−1 is the previous time unit of tnow; L(Ci, tnow), L(Ci, tnow−1), . . . , and L(Ci, tnow-n) respectively indicate counting results about the number of location records that have Ci in different time units; and base(Ci) indicates an attribute calculation result corresponding to Ci.

4. The method for calculating the number of users according to claim 2, wherein the trend calculation result corresponding to the trend attribute combination in a time unit of the time segment to be queried is calculated by using the following formula:
direction(Cᵢ^{d},t_{w})=d_{w}×Day_{avg}(Cᵢ^{d},t_{w})+w_{w}×Week_{avg}(Cᵢ^{d},t_{w})+m_{w}+Month_{avg}(Cᵢ^{d},t_{w})+y_{w}×Year_{avg}(Cᵢ^{d},t_{w});
wherein in the preceding formula,
$${Day}_{avg} ( {C}_{i}^{d} , {t}_{w} ) = \frac{K ( {C}_{i}^{d} , {t}_{Day ( w , 1 )} ) + K ( {C}_{i}^{d} , {t}_{Day ( w , 2 )} ) + … + K ( {C}_{i}^{d} , {t}_{Day ( w , n )} )}{n} ;$$
$${Week}_{avg} ( {C}_{i}^{d} , {t}_{w} ) = \frac{K ( {C}_{i}^{d} , {t}_{Week ( w , 1 )} ) + K ( {C}_{i}^{d} , {t}_{Week ( w , 2 )} ) + … + K ( {C}_{i}^{d} , {t}_{Week ( w , n )} )}{n} ;$$
$${Month}_{avg} ( {C}_{i}^{d} , {t}_{w} ) = \frac{K ( {C}_{i}^{d} , {t}_{Month ( w , 1 )} ) + K ( {C}_{i}^{d} , {t}_{Month ( w , 2 )} ) + … + K ( {C}_{i}^{d} , {t}_{Month ( w , n )} )}{n} ; and$$
$${Year}_{avg} ( {C}_{i}^{d} , {t}_{w} ) = \frac{K ( {C}_{i}^{d} , {t}_{Year ( w , 1 )} ) + K ( {C}_{i}^{d} , {t}_{Year ( w , 2 )} ) + … + K ( {C}_{i ,}^{d} {t}_{Year ( w , n )} )}{n} ; wherein$$
$$K ( {C}_{i}^{d} , {t}_{Day ( w , n )} ) = \frac{L ( {C}_{i}^{d} , {t}_{Day ( w , n )} )}{L ( {C}_{i}^{d} , {t}_{now} )} ;$$
$$K ( {C}_{i}^{d} , {t}_{Week ( w , n )} ) = \frac{L ( {C}_{i}^{d} , {t}_{Week ( w , n )} )}{L ( {C}_{i}^{d} , {t}_{now} )} ;$$
$$K ( {C}_{i}^{d} , {t}_{Month ( w , n )} ) = \frac{L ( {C}_{i}^{d} , {t}_{Month ( w , n )} )}{L ( {C}_{i}^{d} , {t}_{now} )} ; and$$
$$K ( {C}_{i}^{d} , {t}_{Year ( w , n )} ) = \frac{L ( {C}_{i}^{d} , {t}_{Year ( w , n )} )}{L ( {C}_{i}^{d} , {t}_{now} )} ;$$
wherein Cᵢ^{d} indicates an i-th trend attribute combination; and tw indicates a w-th time unit in the time segment to be queried;
Day_{avg}(Cᵢ^{d}, t_{w}) indicates a daily calculation component, and dw indicates a weight of the daily calculation component;
Week_{avg}(Cᵢ^{d}, t_{w}) indicates a weekly calculation component, and ww indicates a weight of the weekly calculation component;
Month_{avg}(Cᵢ^{d}, t_{w}) indicates a monthly calculation component, and mw indicates a weight of the monthly calculation component;
Year_{avg}(Cᵢ^{d}, t_{w}) indicates a yearly calculation component, yw indicates a weight of the yearly calculation component, and d_{w}+w_{w}+m_{w}+y_{w}=1;
t_{Day(w,n)} indicates a time unit in the latest n-th week that has the same date order number as the week to which tw belongs, t_{Week(w,n)} indicates a time unit in the latest n-th month that has the same week order number as the month to which tw belongs, t_{Month(w,n)} indicates a time unit in the latest n-th month that has a different month from and the same date as tw, and t_{Year(w,n)} indicates a time unit in the latest n-th year that has a different year from and the same date as tw;
L(Cᵢ^{d}, t_{Day(w,n)}) indicates a counting result about the number of location records that have Cᵢ^{d} in t_{Day(w,n)}, L(Cᵢ^{d}, t_{Week(w,n)}) indicates a counting result about the number of location records that have Cᵢ^{d} in t_{Week(w,n)}, L(Cᵢ^{d}, t_{Month(w,n)}) indicates a counting result about the number of location records that have Cᵢ^{d} in t_{Month(w,n)}, and L(Cᵢ^{d}, t_{Year(w,n)}) indicates a counting result about the number of location records that have Cᵢ^{d} in t_{Year(w,n)}; and
L(Cᵢ^{d}, t_{now}) indicates a counting result about the number of location records that have Cᵢ^{d} in the latest time unit, and direction(Cᵢ^{d}, t_{w}) indicates a trend calculation result of Cᵢ^{d} in tw.

5. The method for calculating the number of users according to claim 4, wherein the querying, by the computer from a stored attribute-number of location record mapping table, the number of location records corresponding to the attribute parameters to be queried comprises:
querying, from the attribute combinations, an attribute combination comprising the location to be queried, and specifying the attribute combination as a matched attribute combination; and
querying, from the attribute-number of location record mapping table, an attribute calculation result corresponding to the matched attribute combination and a trend calculation result corresponding to a corresponding trend attribute combination in the time to be queried; wherein
the number of location records corresponding to the attribute parameters to be queried comprises the attribute calculation result and the trend calculation result.

6. The method for calculating the number of users according to claim 5, after the specifying the matched attribute combination, further comprising:
dividing, according to the location attributes, the matched attribute combination into matched attribute combination subsets; wherein
the querying, from the attribute-number of location record mapping table, an attribute calculation result corresponding to the matched attribute combination and a trend calculation result corresponding to a corresponding trend attribute combination in the time to be queried comprises:
querying, from the attribute-number of location record mapping table, an attribute calculation result corresponding to each matched attribute combination in the matched attribute combination subsets and the trend calculation result corresponding to the corresponding trend attribute combination in the time to be queried.

7. The method for calculating the number of users according to claim 5, wherein the number of users at the location to be queried in the time to be queried is calculated by using the following formula:
count=Σ(base(MCᵢ)×direction(MCᵢ^{d},t));
wherein Count indicates the number of users; MCi indicates an i-th matched attribute combination, and i is a positive integer; MCᵢ^{d} indicates a trend attribute combination corresponding to MCi; base(MCi) indicates an attribute calculation result corresponding to MCi; and direction(MCᵢ^{d}, t) indicates a trend calculation result corresponding to MCᵢ^{d} in the time t to be queried.

8. The method for calculating the number of users according to claim 2, before the summarizing user attributes and location attributes in the locally stored location records of all users to obtain attribute combinations, further comprising:
periodically recording, by the data collection apparatus according to a time unit, user identifiers, collection time, and location identifiers of users meeting collection conditions; and
performing, by the computer, attribute expansion on the user identifiers and location identifiers according to an attribute database to form location records corresponding to the user identifiers, collection time, and location identifiers.

9. The method for calculating the number of users according to claim 8, wherein the periodically recording, by a data collection apparatus according to a time unit, user identifiers, collection time, and location identifiers of users meeting collection conditions comprises:
recording, by the data collection apparatus according to a record triggering condition, user identifiers, collection time, and location identifiers of users entering and/or leaving a certain location area.

10. The method for calculating the number of users according to claim 1, wherein the receiving a query request that that comprises attribute parameters to be queried and is sent by an enquirer, wherein the attribute parameters to be queried comprises a location to be queried and time to be queried after the current time comprises:
receiving a query request that comprises attribute parameters to be queried and is sent by the enquirer through an electronic map, wherein the attribute parameters to be queried comprise the location to be queried and the time to be queried after the current time;
further comprising: displaying, at the location corresponding to the location to be queried on the electronic map, the number of users at the location to be queried in the time to be queried.

11. The method for calculating the number of users according to claim 10, wherein the receiving a query request that comprises attribute parameters to be queried and is sent by the enquirer through an electronic map comprises:
receiving a query request that comprises attribute parameters to be queried and is sent by the enquirer by operating a display area in the electronic map; or
receiving a query request that comprises attribute parameters to be queried and is sent by the enquirer by operating a time selection control in the electronic map.

12. A system for calculating the number of users, comprising:
a data collection apparatus, configured to collect location information of users; and
a computer, configured to receive, through an input interface, a query request that comprises attribute parameters to be queried and is sent by an enquirer, wherein the attribute parameters to be queried comprise a location to be queried and time to be queried after the current time, then query, from an attribute-number of location record mapping table stored in the computer, the number of location records corresponding to the attribute parameters to be queried, and finally calculate, according to the obtained number of location records, the number of users at the location to be queried in the time to be queried; wherein:
the data collection apparatus connects to another input interface of the computer to transmit the collected location information of users to the computer, so as to form location records corresponding to the collected users in the computer; and
the computer is further configured to establish the attribute-number of location record mapping table according to locally stored location records of users and store the attribute-number of location record mapping table in a memory.

13. The system for calculating the number of users according to claim 12, wherein the computer comprises:
an attribute combination unit, configured to obtain attribute combinations by summarizing user attributes and location attributes in the locally stored location records of users;
a statistic unit, configured to count the number of location records that have the same attribute combination in each time unit;
an attribute calculation unit, configured to calculate, according to a counting result about the number of location records, an attribute calculation result corresponding to the attribute combination;
a trend combination unit, configured to construct a trend attribute combination according to the attribute combination, wherein the trend attribute combination belongs to the attribute combination, and the trend attribute combination at least comprises a location attribute;
a trend calculation unit, configured to calculate, according to a specified time segment to be queried, a trend calculation result corresponding to the trend attribute combination in each time unit of the time segment to be queried; and
a mapping table generation unit, configured to form the attribute-number of location record mapping table by using an attribute calculation result corresponding to each attribute combination and a trend calculation result corresponding to each trend attribute combination in each time unit of the time segment to be queried.

14. The system for calculating the number of users according to claim 13, wherein the computer further comprises:
a matching unit, configured to query, from the attribute combinations, an attribute combination comprising the location to be queried and specify the attribute combination as a matched attribute combination; and
a query unit, configured to query, from the attribute-number of location record mapping table, an attribute calculation result corresponding to the matched attribute combination and a trend calculation result corresponding to a corresponding trend attribute combination in the time to be queried.

15. The system for calculating the number of users according to claim 14, wherein the computer further comprises a dividing unit, configured to divide the matched attribute combination into matched attribute combination subsets according to the location attributes; and
the query unit is further configured to query, from the attribute-number of location record mapping table, an attribute calculation result corresponding to each matched attribute combination in the matched attribute combination subsets and a trend calculation result corresponding to a corresponding trend attribute combination in the time to be queried.

16. The system for calculating the number of users according to claim 12, wherein the data collection apparatus is further configured to periodically record, according to a time unit, user identifiers, collection time, and location identifiers of users meeting collection conditions; and
the computer comprises an attribute expansion unit, configured to perform attribute expansion on the user identifiers and location identifiers according to an attribute database to form location records corresponding to the user identifiers, collection time, and location identifiers.

17. The system for calculating the number of users according to claim 16, wherein the data collection apparatus is further configured to record, according to a record triggering condition, user identifiers, collection time, and location identifiers of users entering and/or leaving a certain location area of the positioning system.

18. The system for calculating the number of users according to claim 12, wherein the computer comprises a receiving unit, configured to receive, through the input interface, a query request that comprises attribute parameters to be queried and is sent by the enquirer through an electronic map, wherein the query request comprises the location to be queried and the time to be queried;
further comprising a display, configured to display the electronic map, and display, at the location corresponding to the location to be queried on the electronic map, the number of users at the location to be queried in the time to be queried.

19. The system for calculating the number of users according to claim 18, wherein the receiving unit is further configured to receive a query request that comprises attribute parameters to be queried and is sent by the enquirer by operating a display area in the electronic map; or receive a query request that comprises attribute parameters to be queried and is sent by the enquirer by operating a time selection control in the electronic map.
